(19) United States
(12) Patent Application Publication
(10) Pub. No.: US 2007/0225993 A1
(43) Pub. Date: Sep. 27, 2007

(54) Method for Civilly-Catastrophic Event-Based Transport Service and Vehicles Therefor

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/551,083

(22) Filed: Oct. 19, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.
Application No. 11/381,277 is a continuation-in-part of application No. 11/383,022, filed on May 12, 2006.
Application No. 11/383,022 is a continuation-in-part of application No. 11/420,594, filed on May 26, 2006.
Application No. 11/420,594 is a continuation-in-part of application No. 11/421,694, filed on Jun. 1, 2006.
Application No. 11/421,694 is a continuation-in-part of application No. 11/423,594, filed on Jun. 12, 2006.
Application No. 11/423,594 is a continuation-in-part of application No. 11/425,043, filed on Jun. 19, 2006.
Application No. 11/425,043 is a continuation-in-part of application No. 11/426,231, filed on Jun. 23, 2006.
Application No. 11/426,231 is a continuation-in-part of application No. 11/456,472, filed on Jul. 10, 2006.
Application No. 11/456,472 is a continuation-in-part of application No. 11/461,605, filed on Aug. 1, 2006.
Application No. 11/461,605 is a continuation-in-part of application No. 11/461,624, filed on Aug. 1, 2006.
Application No. 11/461,624 is a continuation-in-part of application No. 11/462,795, filed on Aug. 7, 2006.
Application No. 11/462,795 is a continuation-in-part of application No. 11/462,845, filed on Aug. 7, 2006.
Application No. 11/462,845 is a continuation-in-part of application No. 11/464,751, filed on Aug. 15, 2006.
Application No. 11/464,751 is a continuation-in-part of application No. 11/464,764, filed on Aug. 15, 2006.
Application No. 11/464,764 is a continuation-in-part of application No. 11/464,775, filed on Aug. 15, 2006.
Application No. 11/464,775 is a continuation-in-part of application No. 11/464,788, filed on Aug. 15, 2006.
Application No. 11/464,788 is a continuation-in-part of application No. 11/464,799, filed on Aug. 15, 2006.
Application No. 11/464,799 is a continuation-in-part of application No. 11/465,063, filed on Aug. 16, 2006.
Application No. 11/465,063 is a continuation-in-part of application No. 11/466,727, filed on Aug. 23, 2006.
Application No. 11/466,727 is a continuation-in-part of application No. 11/466,953, filed on Aug. 24, 2006.
Application No. 11/466,953 is a continuation-in-part of application No. 11/470,156, filed on Sep. 5, 2006.
Application No. 11/470,156 is a continuation-in-part of application No. 11/531,651, filed on Sep. 13, 2006.
Application No. 11/531,651 is a continuation-in-part of application No. 11/532,461, filed on Sep. 15, 2006.
Application No. 11/532,461 is a continuation-in-part of application No. 11/535,021, filed on Sep. 25, 2006.
Application No. 11/535,021 is a continuation-in-part of application No. 11/535,282, filed on Sep. 26, 2006.
Application No. 11/535,282 is a continuation-in-part of application No. 11/537,469, filed on Sep. 29, 2006.
Application No. 11/537,469 is a continuation-in-part of application No. 11/539,798, filed on Oct. 9, 2006.
Application No. 11/539,798 is a continuation-in-part of application No. 11/539,861, filed on Oct. 9, 2006.
Application No. 11/539,861 is a continuation-in-part of application No. 11/548,191, filed on Oct. 10, 2006.
Application No. 11/548,191 is a continuation-in-part of application No. 11/549,874, filed on Oct. 16, 2006.
Application No. 11/549,874 is a continuation-in-part of application No. 11/550,594, filed on Oct. 18, 2006.
(60) Provisional application No. 60/820,628, filed on Jul. 28, 2006.
(60) Provisional application No. 60/823,806, filed on Aug. 29, 2006.
(60) Provisional application No. 60/825,524, filed on Sep. 13, 2006.
(60) Provisional application No. 60/825,976, filed on Sep. 18, 2006.
(60) Provisional application No. 60/826,491, filed on Sep. 21, 2006.
(60) Provisional application No. 60/827,591, filed on Sep. 29, 2006.
(60) Provisional application No. 60/827,820, filed on Oct. 2, 2006.
(60) Provisional application No. 60/827,828, filed on Oct. 2, 2006.
(60) Provisional application No. 60/828,341, filed on Oct. 5, 2006.
(60) Provisional application No. 60/828,342, filed on Oct. 5, 2006.
(60) Provisional application No. 60/829,447, filed on Oct. 13, 2006.
(60) Provisional application No. 60/829,779, filed on Oct. 17, 2006.

(51) Int. Cl. G06Q 10/00

(52) U.S. Cl. 705/1

(57) ABSTRACT

Consideration-based private civil security subscriptions from subscribers is provided with respect to providing civilly-catastrophic event-based access to at least transport service for at least authorized beneficiaries. Arrangements are provided for at least the transport service. This includes determining at least one pick-up location for collecting at least one authorized beneficiary by at least one vehicle and in association with a civilly-catastrophic event.

### RELATED APPLICATIONS

This application claims the benefit of the filing date of U.S. Provisional Patent Application Nos. 60/820,628; 60/823,806; 60/825,524; 60/825,976; 60/826,491; 60/827,591; 60/827,820; 60/827,828; 60/828,341; 60/828,342; 60/829,447; and 60/829,779, which are hereby incorporated in their entirety herein.

This application comprises a continuation-in-part of each of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

PRIVATELY PROVISIONED SURVIVAL SUPPLIES DELIVERY METHOD as filed on Aug. 15, 2006 and having application Ser. No. 11/464,751;

PRIVATELY PROVISIONED SURVIVAL SUPPLIES SUB-UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM-BASED PRIVATE CIVIL SECURITY POLICY METHODS as filed on Aug. 24, 2006 and having application Ser. No. 11/466,953;

SUBSCRIPTION-BASED MOBILE SHELTER METHOD as filed on Sep. 5, 2006 and having application Ser. No. 11/470,156;

METHOD OF PROVIDING A FLOATING LIFE-SUSTAINING FACILITY as filed on Sep. 13, 2006 and having application Ser. No. 11/531,651;

PRIVATELY PROVISIONED SUB-UNIT-BASED SURVIVAL SUPPLIES PROVISIONING METHOD as filed on Sep. 15, 2006 and having application Ser. No. 11/532,461;

PRIVATELY PROVISIONED INTERLOCKING SUB-UNIT-BASED SURVIVAL SUPPLIES PROVISIONING METHOD as filed on Sep. 25, 2006 and having application Ser. No. 11/535,021;

RESOURCE CONTAINER AND POSITIONING METHOD AND APPARATUS as filed on Sep. 26, 2006 and having application Ser. No. 11/535,282;

PUBLICLY-FUNDED PRIVATELY FACILITATED ACCESS TO SURVIVAL RESOURCES METHOD as filed on Sep. 29, 2006 and having application Ser. No. 11/537,469;

ELECTRICITY PROVIDING PRIVATELY PROVISIONED SUBSCRIPTION-BASED SURVIVAL SUPPLY UNIT METHOD AND APPARATUS as filed on Oct. 9, 2006 and having application Ser. No. 11/539,798;

PREMIUM-BASED CIVILLY-CATASTROPHIC EVENT THREAT ASSESSMENT as filed on Oct. 9, 2006 and having application Ser. No. 11/539,861;

PRIVATELY MANAGED ENTERTAINMENT AND RECREATION SUPPLIES PROVISIONING METHOD as filed on Oct. 10, 2006 and having application Ser. No. 11/548,191;

METHOD TO FACILITATE PROVIDING ACCESS TO A PLURALITY OF PRIVATE CIVIL SECURITY RESOURCE as filed on Oct. 16, 2006 and having application Ser. No. 11/549,874; METHOD OF PROVIDING BEARER CERTIFICATES FOR PRIVATE CIVIL SECURITY BENEFITS as filed on Oct. 18, 2006 and having application Ser. No. 11/550,594;

the contents of each of which are fully incorporated herein by this reference.

### TECHNICAL FIELD

This invention relates generally to facilitating transportation in relation to a civilly catastrophic event.

### BACKGROUND

As powerful as the machinery of modern life appears, modern citizens are today perhaps more at risk of experiencing a serious disruption in their ability to prosper or even to survive en mass than is generally perceived. A serious disruption to any significant element of civilized infrastructure can produce catastrophic results for a broad swatch of a given civil community. Any number of natural and/or intentionally-caused events can significantly disrupt society's infrastructure and present a variety of differing threats and problems to the individual.

Many people believe and trust that their government (local, regional, and/or national) will provide for them in the event of such catastrophic occurrences. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic transportation needs to move people to safety when a large-scale catastrophic event occurs. One may also observe that most communities simply cannot afford to staff and support a contingent capability to deal with a wide variety of likely infrequent and possibly unpredictable extreme events.

When a civilly-catastrophic event occurs, substantially sudden civil upheaval will often follow. Not only will many significant elements of society's infrastructure be seriously disrupted, but people in general are known to act in ways that are different and sometimes unexpected when faced with circumstances that threaten their well being or survival. This, coupled with the characterizing effects of the civilly-catastrophic event itself, can present an affected person with numerous challenges.

In many cases it may be useful or even critical to at least temporarily evacuate the troubled location. Therein, however, lies something of a conundrum. On the one hand, modern governments typically do little to proactively ensure the ability to quickly and safely effect transport and care of their citizens in the face of many civilly-catastrophic events. On the other hand, even if governments attempt to provide needed transportation vehicles before, during or after such catastrophic events, infrastructure such as roads, bridges, airports, and highways may be damaged or impassable rendering the transportation vehicles provided by the government too slow or even useless. Moreover, not all communities or governments have the logistical or financial ability to provide alternate transportation and preplan emergency routes for evacuation to quickly respond to an effected area. As witnessed by the effects of hurricane Katrina, it may be days or even weeks before regional, local, and national governments can immobilize and provide sufficient transportation from affected areas of greatest need.

Many catastrophic events are survivable presuming one has access to suitable evacuation transportation services and equipment associated therewith. It is possible, of course, for individuals to plan evacuation procedures and equip themselves with vehicles accordingly in advance of any catastrophic event. Such an approach, however, presents a number of corresponding problems and issues. Attempting to take responsible actions to reasonably ensure one's own abilities in this regard can become, in and of itself, a seemingly insurmountable challenge. The individuals may simply lack access to the appropriate resources or may be inhibited by the costs, expertise, skills, or abilities involved. In addition, an individual may take the time to plan for evacuations and obtain an appropriate vehicle and equipment, but if the civilly catastrophic event is of a type not predicted and/or causes damage to infrastructure in an unpredicted manner such that the planning and equipment is not suited for the resulting conditions caused by the civilly catastrophic event, the planning and equipment may be rendered useless. As a result, the time and energy used to plan evacuation procedures and acquire needed vehicles and/or equipment would be wasted.

For these and other reasons, most if not all persons are typically bereft of a suitable transportation service that can be readily and quickly accessed in a time of need.

### BRIEF DESCRIPTION OF THE DRAWINGS

The above needs are at least partially met through provision of the method for civilly catastrophic event-based transport service and vehicles therefor described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram view as configured in accordance with various embodiments of the invention; and

FIG. 4 comprises a block diagram view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENT

Generally speaking, pursuant to these various embodiments, one provides a subscription-based approach to facilitate transport services for authorized beneficiaries before an imminent threat of, during, or after the occurrence of a civilly-catastrophic event. Consideration-based private civil security subscriptions are accepted from one or more subscribers with respect to providing civilly-catastrophic event-based access to at least the transport service. For the transport service, one or more stops or pick-up locations are determined for collecting at least authorized beneficiaries by at least one vehicle and in association with the civilly catastrophic event. By one approach, the transport service is provided to evacuate the authorized beneficiaries and bring them to safety. Various other approaches are set forth with respect to providing arrangements for implementing the transport service.

So configured, the subscriber or corresponding authorized beneficiaries (defined below) of such consideration-based private civil security subscriptions will have predictable access to transport service upon the occurrence (or threat) of a catastrophic event. In this manner, one or more vehicles are sent to pick-up locations to collect the authorized beneficiaries according to schedules communicated to the authorized beneficiaries. The nature, kind, and number of vehicles can vary with the needs of the situation presented by the civilly-catastrophic event. The pick-up locations and routes therebetween may be carefully identified to maximize the safety of the authorized beneficiaries both for their travel to the pick-up locations and while traveling in or on the vehicle. The final destinations of the vehicle may be any one that is applicable in a given application setting including destinations chosen by the authorized beneficiaries. The authorized beneficiaries having access will be comforted with the safe and convenient transport service preferably planned, operated, and maintained by experts and hence relieve the authorized beneficiary of responsibility in this regard.

These steps are facilitated without dependency upon governmental oversight, participation, or control. The particular transport services provided can vary with the needs and requirements of the subscriber or authorized beneficiaries. Importantly, via these teachings, an individual can take important steps to bring a considerably improved measure of security into their lives, knowing that, should a civilly-catastrophic event indeed be visited upon them, they will be transported and moved, safely and effectively, from a location of (and possibly through) civil upheaval.

These and other benefits may become clearer upon making a thorough review and study of the following detailed description. Referring now to FIG. 1, an illustrative process 100 includes accepting 101 consideration-based private civil security subscriptions (designated numeral 403 on FIG. 4) from one or more subscribers with respect to providing civilly-catastrophic event-based access to at least the transport service. This right of access can pertain, if desired, to a predetermined period of time. For example, a given subscription 403 can relate to providing access to the transport service for a one year period of time for one or more authorized beneficiaries as correspond to that subscription. If desired, a given subscription can further provide for transportation back to the original location of civic upheaval following substantial quelling of that civil upheaval. This transportation may be by the at least one vehicle as was used to originally convey the authorized beneficiaries away from that location or may comprise other more customary civilian-styled transport (presuming, for example, that obstacles and inhibitions with respect to transport are no longer as extreme as when the original transport was provided).

By one approach, these subscriptions may be accepted by, for example, a for-profit business. By another approach a not-for-profit business (such as a membership-based entity) may be the appropriate entity to offer and accept such subscriptions. As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extends past the death of a named subscription beneficiary and further allows for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a one-time-only right of access or a perpetual right of access that may be retained, transferred, inherited, or the like);

ownership-based rights of access (as may occur when the subscription provides for ownership rights with respect to the survival supplies);

non-transferable rights of access (as may occur when the subscription, by its terms and conditions, prohibits transfer of the right of access to the survival supplies from a first named beneficiary to another);

transferable rights of access (as may occur when the subscription, by its terms and conditions, permits conditional or unconditional transfer of the right of access from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided or undivided co-ownership interest by and between multiple subscription beneficiaries with respect to a right to access the survival supplies);

non-ownership-based rights of access (as may occur when the subscription, by its terms and conditions, establishes the aforementioned right of access via, for example, a lease, rental, or borrowing construct);

an option-based right of access (as may occur when the subscription, by its terms and conditions, establishes a right for an authorized beneficiary to later obtain access to some or all such transportation resources upon, for example, paying an additional supplemental amount at that time); and/or

a credit-based right of access (as may occur when a given individual predicates their right to access the aforementioned transportation upon a representation, promise, or other credit-based transaction).

If desired, a plurality of differentiated subscription opportunities can be offered. This plurality of differentiated subscription opportunities can correspond, for example, to providing access to differing transportation modalities, transport accommodations, pick-up locations, destinations, speed of service, and so forth. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing transport services that are economically selected (by excluding, for example, certain options such as medical services or amount or durability of armor or the like) while another subscription might provide for rescue services that are more costly and in turn reflect, for example, a wider variety of choices with respect to rescue modality, safety, accommodations, service options, creature comforts, and so forth. Other possibilities are contemplated.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions relate to providing access to transport service upon the occurrence or threat of a civilly-catastrophic event. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice. In addition, or in lieu thereof, such access may be predicated, if desired, upon a requirement of a particular level of objectively or subjectively ascertained likelihood that a particular category or kind of civilly-catastrophic event will occur within a particular period of time.

As used herein, “civilly-catastrophic event” will be understood to refer to an event that substantially and materially disrupts a society's local, regional, and/or national infrastructure. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of non-naturally-caused disasters capable of initiating a civilly-catastrophic event include both unintended events as well as intentional acts of war, terrorism, madness or the like. Examples of non-naturally-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, relatively widespread exposure to a harmful mutagenic influence, and so forth.

It would also be possible to supplement such access by permitting access to the transport service upon the occurrence of some other event or circumstance that might present the authorized beneficiary with a serious challenge while not itself necessarily rising to the level of a civilly-catastrophic event. For example, if desired, access to the subscribed-to transportation opportunity might be permitted when an authorized beneficiary's home is destroyed by fire. A number of approaches for providing transport service are described below.

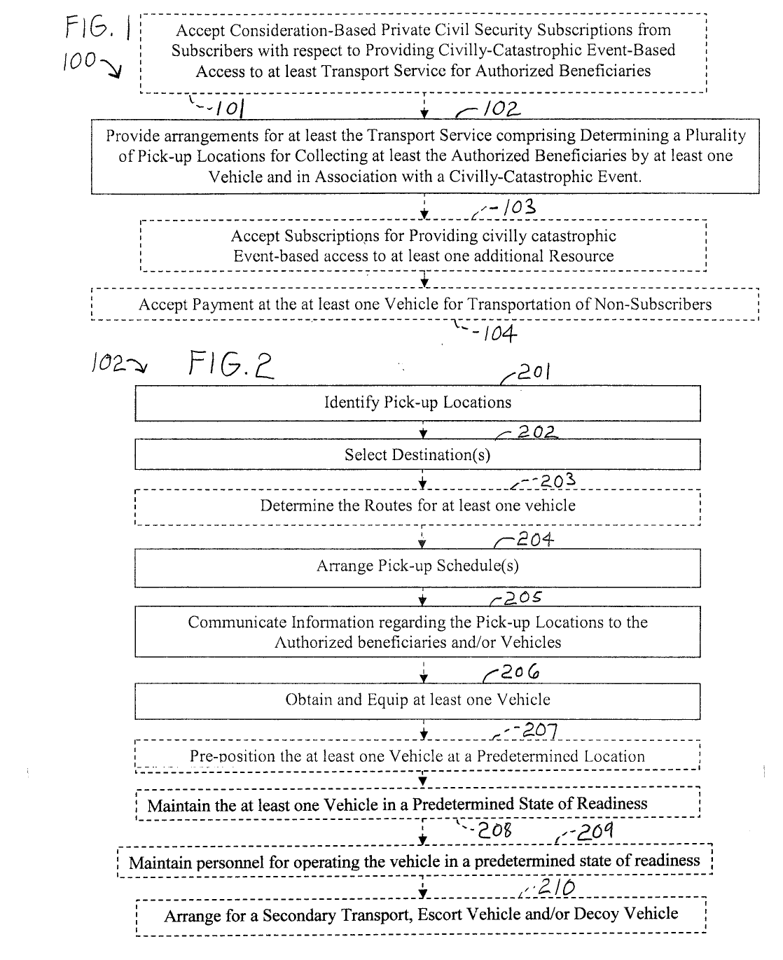

Referring now to FIGS. 1-2, the illustrative process 100 includes providing arrangements 102 for at least the transport service. By one approach, providing arrangements 102 comprises determining at least one pick-up location for collecting at least one authorized beneficiary by at least one vehicle and in association with a civilly-catastrophic event. This service may be needed when the civilly-catastrophic event substantially disrupts society's infrastructure, and in turn, an authorized beneficiary's ability to exist safely at their pre-civilly catastrophic event location. This location may be the authorized beneficiary's home, work, and so forth. After traveling to a designated pick-up location, the authorized beneficiary may board the vehicle provided and be safely evacuated from an area that is, or likely will be, impacted and adversely affected by the civilly-catastrophic event.

Thus, the transport service may be activated (vehicle(s) sent to the pick-up locations, for example) before a predicted time of occurrence of the civilly-catastrophic event, during the civilly-catastrophic event, and/or after the civilly catastrophic event. Depending on the significance and likelihood of the threat, authorized beneficiaries may want to stay at their homes until the last possible moment before it is necessary to evacuate with time to travel to a pick-up location and avoid the event still remaining. The transport service permits this to be done safely. Authorized beneficiaries who are trapped in the civilly-catastrophic event and are able to reach the pick-up locations may still be picked up during or after the event by vehicles of the transport service properly equipped and chosen to handle the conditions of a particular type and strength of civilly-catastrophic event.

Providing arrangements 102 to determine the pick-up locations comprises certain main steps. These include but are not limited to identifying 201 the pick-up locations, determining 202 a destination or destinations, and determining 203 the route to be taken. Each of these considerations is discussed in detail below.

By one approach, all of these steps may be performed well before an imminent threat of a predictable catastrophic event. For instance, preliminary, primary, and contingency plans for transport service for the advent of earthquakes in California, hurricanes and floods in the southern United States and river beds, tornados in the Midwest, and so forth may be established, and then adjusted in light of an imminent threat of a specific event. Alternate plans may be established for each main step as needed depending on, for example, the magnitude of the event as well as many other known factors.

Of course, many civilly-catastrophic events cannot be predicted. In these cases, the main steps for planning the transport service must occur during an imminent threat of, during, or after the civilly-catastrophic event as is needed. When preliminary plans are already established, these plans may be adjusted to form new usable plans rather than starting a plan from scratch. In certain circumstances, there may be no choice but to create a new transport service plan.

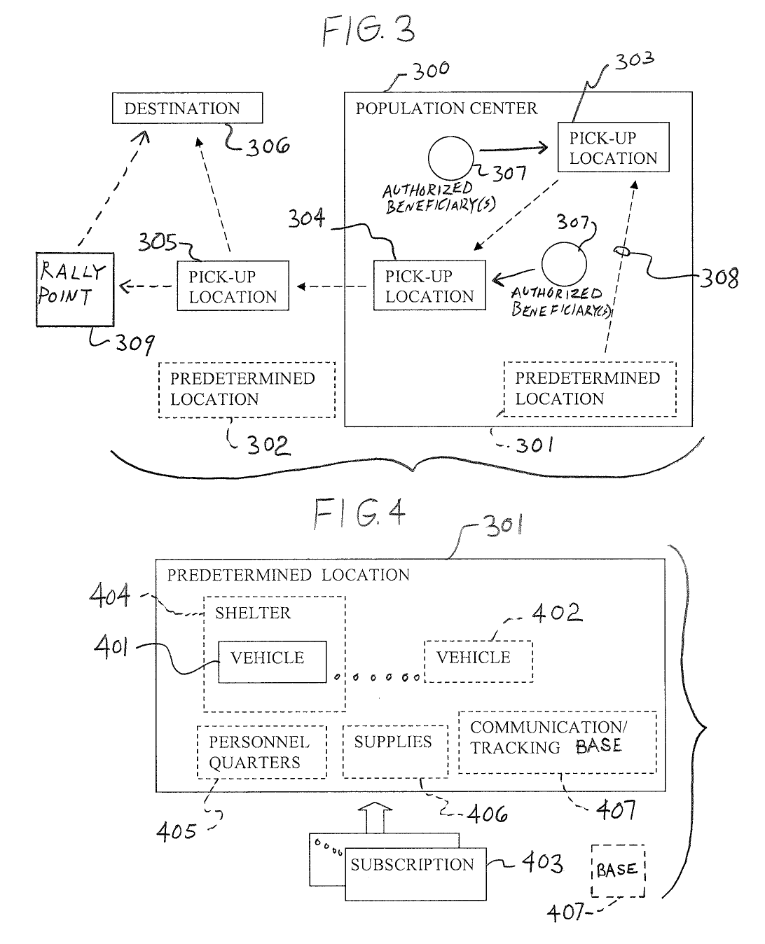

Referring to FIG. 3, the pick-up locations 303-305 can be identified 201 by considering a number of factors. One factor is the location of the authorized beneficiaries 307. By one approach, the pick-up locations 303-305 are positioned in the vicinity of the authorized beneficiaries 307 so that it is not unreasonable to expect healthy authorized beneficiaries to walk or otherwise travel a short distance to the pick-up locations. Thus, the pick-up locations 303-305 are provided within a few miles or less from the location of authorized beneficiaries 307, and any number of pick-up locations 303 and 304 may be provided in a single population center 300 (such as a city or large town). In this way, the pick-up locations 303-305 may be any easily recognizable and/or easy to find locations such as a certain stadium, arena, famous or well-known building, statute, monument, transportation depot, well-known park, beach, or harbor to name a few examples. By alternative approaches, the pick-up locations 303-305 may be provided at farther or closer distances from the authorized beneficiaries.

Another factor for identifying 201 the pick-up locations 303-305 is the accessibility of the location to one or more modes of transportation. Thus, in some circumstances, the pick-up location 303 may be at a seaside dock accessible to boats and cars, an airport accessible to air-borne vehicles and cars, a railroad station near major roadways, or any other place accessible to at least two modes of transportation. The pick-up location 303 may also simply be a large empty field or flat surface accessible by both terrestrial and/or an air-borne vehicle. Many other examples are contemplated.

Identifying 201 the pick-up locations 303-305 may also include choosing locations that are along a selected course or route 308 to a particular pick-up location 303-305 or other final destination 306. For example, a vehicle 401 may stop at the pick-up locations 303-305 in sequential order from east to west or by any other practical order. The route 308 may be chosen to reduce costs, conserve fuel, or reduce travel time. Many other factors may be applied for choosing the route. For example, a given subscription may provide for a higher priority for a given authorized beneficiary and in such a case, a pick-up location as corresponds to that authorized beneficiary might be scheduled in a manner that would otherwise appear to place it out of order with respect to other pick-up locations for that particular route. It will also be understood that the route 308 may be provided for air, sea, or land travel or any combination thereof and is not limited to any type or mode of travel. For example, a route may be a series of roof tops that a helicopter lands on, a series of boat docks, piers, or other landings along a shore of a body of water, a number of air strips an airplane lands on, and so forth.

Yet another factor for identifying 201 the pick-up locations 303-305 is consideration of the safety of the vehicle and/or crew, the authorized beneficiaries, and the property thereof at the pick-up locations. In order to determine the safety level at any particular pick-up location, the nature of the civilly-catastrophic event can be considered. This may be the predicted nature of the event if the event has not occurred yet or it may be the real conditions caused by the event. This may be performed by monitoring the pick-up locations with surveillance equipment such as, but not limited to, satellite-based cameras and sensors, local cameras (which may be night-vision capable), climate and ground movement sensors, direct visual observation, unmanned aerial vehicles (UAVs), and so forth. National and local media, broadcasts and other television, radio, computer, or Internet reports may be monitored for weather or other conditions as well.

As another factor, the societal infrastructure status in light of the civilly-catastrophic event may also be monitored. For instance, a civilly catastrophic event may cause governmental law enforcement forces and militaries to collapse on a local, national, or global scale. This may promote or prompt people or situations that are dangerous to the authorized beneficiaries, their property, and their ability to travel. This can include, but is not limited to, general social unrest, civil disobedience, criminal activity (including looting and other crimes of opportunity), private militias, rebel groups, terrorists, rogue military factions, or the like. To observe these conditions, the transport service can arrange to have scouts, reconnaissance personnel, or the like that are charged with observing the pick-up locations and reporting social conditions or the like. Such personnel could be highly trained in stealth tactics to avoid detection if so required. It will be appreciated that personnel may also be employed to protect and/or maintain possession and control of pick-up locations in order to better assure safety at those locations by whatever force is deemed appropriate and within the ambit of existing law.

Referring to FIGS. 2-4, identifying 201 the pick-up locations may also include considering the initial location or locations of the vehicle or vehicles 401 to be used for the transport service. By one approach, at least one vehicle 401 is pre-positioned 207 at a predetermined location 301. By one approach this may comprise, or be preceded by, optionally obtaining 206 the vehicle 401 by acquiring an exclusive right or a non-exclusive right to operate the vehicle 401. There are many ways by which such an exclusive or non-exclusive right can be so acquired. A non-exhaustive listing might include, but is not limited to, acquiring the exclusive right or non-exclusive right via ownership, leasing, rental, or even a barter arrangement. If desired, of course, one might even design and build the vehicle themselves.

By another approach, instead of predetermined location(s) 301, the vehicles are obtained on a need-basis. In this case, agreements may be in place with manufacturers or dealers of such vehicles to store or make the vehicles to specifications and deliver them in a just-in-time-delivery type of arrangement. This provides adaptability for the transport service to obtain vehicles that a particular type of civilly catastrophic event suggests such as boats for floods, buses for an evacuation of a large number of associated beneficiaries by available roadways, and so forth.

When using the predetermined locations 301, however, in many cases it may be helpful to dispose such a predetermined location 301 relatively proximal to one or more authorized beneficiaries 307 and in turn the pick-up locations 303-305. Such a position may aid with facilitating the timely transport of such authorized beneficiaries 307 during a time of need. Such proximity may be measured, for example, by distance and/or by a period of time as may reasonably be required to traverse the distance between the predetermined location 301 and at least some of the pick-up locations 303-305. Sensitivities in this regard may vary in response to various influences including but not limited to subscriber (or authorized beneficiary) wishes, applicable relevant threat scenarios, and the like. In some cases, as when a number of pick-up locations exist in a significant population center 300, it may be useful to dispose a (or an additional) predetermined location 301 within the population center 300 itself.

In other cases, the predetermined location may be an airstrip or harbor when the vehicle 401 is an air-borne or water-borne vehicle. Accordingly, if desired, the predetermined location 301 may include or be an airstrip or harbor of sufficient length, width, and durability as to respectively accommodate the air-borne or water-borne vehicle of choice. The airstrip or harbor may be equipped as is known, and by one approach, is reserved for ordinary use by only the pre-positioned vehicle 401 (and/or other vehicles as shall be allied with the subscribed-to purpose). By this approach the airstrip or harbor would be closed to other unrelated traffic and purposes.

Referring to FIGS. 2-3, providing 102 arrangements for at least the transport service also includes selecting 202 the destination(s) 306 for the authorized beneficiaries. By one approach, the authorized beneficiaries 307 may be moved to a rally point 309 where they (and possibly other authorized beneficiaries) are then transported by a shuttle, whether by air, sea, or land, to a shelter, a safe location, another rally point, or a location chosen by the authorized beneficiaries as the final destination 306 (to note but a few examples in this regard). In the alternative, or as deemed necessary due to the circumstances, the transport service brings the authorized beneficiaries directly to the final destination 306.

By one approach, the shelter is an emergency shelter configured to be inhabited at least during the civilly-catastrophic event. Alternatively, a short-term shelter may be the destination 306 and may be configured to be inhabited for a defined relatively short-term duration. Thus, this destination may be stocked with survival supplies to last only a certain number of days or weeks. As another option, a long-term shelter may be the destination 306 that is configured to be inhabited for a relatively long-term period such as weeks or months (which may also be called “medium-term” depending upon the applicable time period), years, or for an indeterminate period of time. Such a shelter may be fully or partially (or wholly) self-sustaining. Otherwise, the destination 306 may simply be another pick-up location, any location having survival supplies, and/or a location a predetermined distance away from the civilly-catastrophic event such that the authorized beneficiaries at the location are relatively safe from the civilly-catastrophic event. This may be a location that is found to have safe radiation or toxin levels, may have no more than tolerable infrastructure damage, and/or may be deemed a sufficient distance away from civil unrest such that violence caused by uncontrolled humans is unlikely to reach the safe location. By another approach, the destination 306 is a location for reuniting authorized beneficiaries of a related group of authorized beneficiaries (such as a family, co-workers for a given business, members of a congregation, and so forth). In one of many examples, a separate vehicle may be collecting children at or near a school while the parents use the transport service to meet the children at a certain destination 306. Many other examples exist.

While determining the routes to the pick-up locations may be performed in conjunction with identifying the pick-up locations 303-305 as mentioned above, by another approach, providing arrangements 102 also includes determining 203 the routes to the pick-up locations after the pick-up locations are set. Regardless, the routes may still be determined or adjusted before (the occurrence of), during, or after the civilly-catastrophic event. In one example, the drivers of the vehicles may be told the pick-up locations, destinations, and conditions but may be permitted to use their own professional judgment, training, experience, and instinct to determine the final route to the pick-up locations. This may be accomplished with the help of professional reconnaissance and surveillance staff and procedures as mentioned previously. By other approaches, the best route based on the latest information is provided to the drivers, and the drivers are then expected to strictly adhere to the route unless special circumstances (unforeseen road blockages, bad weather that prevents air travel, and so forth) warrant any deviation. It will also be understood that deviations and changes to the route may occur while the vehicle is traveling to the pick-up locations.

By one approach, one route exists for all pick-up locations and one vehicle is sent to sequentially stop at all of the pick-up locations one after the other in a specified or logical order. By other approaches, two or more vehicles are used to cover a single route where the passengers must transfer from one vehicle that ends its portion of the route to the next vehicle that begins its portion of the route. This may be due to efficiency (the cost of fuel for example), the required transport mode for a particular portion of the route (to cross a river, a vast space, or difficult terrain to name a few examples), and/or the equipment required on the vehicle for a particular portion of the route (armor, medical supplies, and so forth). By another approach, a number of vehicles are sent out to a number of separate routes. In one example, each vehicle is sent out to a single pick-up location.

It will also be understood that which vehicles are assigned to which routes may change to adapt to changing circumstances. Thus, a vehicle may break down or may be stopped by unforeseen infrastructure damage, such as by flooding, a bridge that is damaged, and so forth, and another vehicle may be sent to take its place from another location and continue the route. In another possible example, the effects of the civilly-catastrophic event may have unpredictably increased speed and/or changed direction, thereby requiring more vehicles to be sent to a number of pick-up locations in order to speed up the evacuation of the authorized beneficiaries. Many other examples exist.

Providing arrangements 102 for at least the transport service also include arranging 204 or developing a pick-up schedule to be provided to the authorized beneficiaries (and other non-subscribers as is deemed appropriate). The schedule may list the arrival times that a vehicle will be present at each of the pick-up locations. (As used herein, it will be understood that “arrival time” can comprise a discrete time (such as, for example, “9:30 AM” or can comprise a time range such as, for example, “Within thirty minutes on either side of noon,” or “Before sunset.”) The authorized beneficiary could then be provided with an opportunity to pre-select which pick-up location will be their primary stop and then plan how they will travel to their primary pick-up location.

Providing arrangements 102 can further include communicating 205 information to the authorized beneficiaries that may facilitate the authorized beneficiaries ability to use the transport service. In one instance, the information communicated is the pick-up schedule. The schedules may be in writing and sent to the authorized beneficiaries, may be transmitted to the authorized beneficiaries in electronic, visual, or audio form, and/or may be posted at convenient private or public locations that will be readily viewable by the authorized beneficiaries. In any of these cases, the communication may include instructions for finding the schedule rather than including the schedule itself. The communications may also include a change for a pick-up schedule and/or instructions on how the authorized beneficiaries can determine if the schedule has changed at a particular time such as before, during, or after a civilly-catastrophic event. Thus, the authorized beneficiaries may be informed that if cellular and hardwired telephone and computer network services are unavailable, the pick-up schedules will be transmitted by satellite phones provided by the transport service providers (or those associated therewith).

The communicated information may also include the protocol for the pick-up location. For example, this may include how to approach the vehicle and identify oneself as a “friendly,” how to board the vehicle, the order for boarding, how long the vehicle will stay at the pick-up location, what, if any, luggage is permitted, and so forth.

By another approach, the communication to the authorized beneficiaries includes identification of at least one vehicle or a crew member on the vehicle that is coming to pick them up at the pick-up location. Thus, an authorized beneficiary can be assured that he is with the proper transport service that will keep him or her safe and is less likely to fall prey to a fabricated or mistaken opportunity.

By yet another approach, the communication to the authorized beneficiaries may include information on what type of identification the authorized beneficiary may be required to bring to the pick-up location to gain authorization to board the at least one vehicle. This may include informing the authorized beneficiary to bring identification cards, membership cards, electronic tag cards, photographs, identifying documents, and/or the like. The authorized beneficiary may also be provided with a pass code and/or a password, or may be informed that biometrically-based identification (such as finger prints, retinal scans, and so forth) will be required.

By a further approach, the authorized beneficiaries may also be told how much storage space and how much carry-on baggage space is provided by a particular vehicle. Thus, authorized beneficiaries may be informed of the type of supplies provided by the vehicle and instructed as to how much personal property (by weight, volume, and so forth) if any is permitted, and if any restrictions exist as to the type of property that is allowed on board (such as weapons, pets, and so forth). This information may also indicate whether any space is presently available to accommodate non-subscribers who might wish to accompany the authorized beneficiary (such as visiting relatives, children's friends, or the like).

The information may be communicated to the authorized beneficiaries as needed and depending on the circumstances relating to the civilly-catastrophic event. Such information can be encrypted, if desired, or can be presented in a coded format to prevent unauthorized persons from making inappropriate use of the information. Thus, as much information as possible can be provided before an imminent threat of the civilly-catastrophic event and may include pick-up location information as described above that can be pre-planned as a function, at least in part, of the likelihood of an occurrence in a particular area of a given event (such as hurricanes, tornados, floods, earthquakes, or the like). Otherwise, the communication may be communicated after the civilly-catastrophic event is predicted to likely occur but before the civilly-catastrophic event occurs to provide the most up to date information. Communications regarding changes in the pick-up schedule for instance, may also be sent during or after the civilly-catastrophic event occurs, before the at least one vehicle is traveling to at least one pick-up location, while the at least one vehicle is traveling to at least one pick-up location, while the at least one vehicle is waiting at least one pick-up location, and/or after the at least one vehicle leaves at least one pick-up location. Thus, authorized beneficiaries may receive real time (or substantially real time) information on the location of the vehicle and/or schedule changes so that the authorized beneficiaries can be diverted to an appropriate pick-up location when certain pick-up locations must be skipped (due to infrastructure damage or any other reason), the vehicle arrives at the pick-up location at a different time than was scheduled, and/or when an authorized beneficiary could not make it in time to his or her primary pick-up location.

In order to communicate with the authorized beneficiaries, the authorized beneficiaries may be provided with a communication device for communicating with the operators of the transport service at a communications base 407 (FIG. 4) that may be co-located at a predetermined location 301 that stores the vehicle 401 or a base 407 that is alternatively at a separate location remote from the vehicle. The communication device may also be used to communicate with the vehicle 401 itself as already alluded to. The communication device may also be provided so that authorized beneficiaries can communicate with other parties designated by the acceptor of the subscriptions, family, friends, authorities, or the like or to receive news and critical information about the civilly catastrophic event and governmentally issued evacuation instructions or information as to safe pick-up locations, rally points, and/or destinations.

The communication devices may comprise, as desired, one-way (receivers or transmitters) and/or two-way (transceiver) communication devices. The communication device may be a telephone configured to be hard-wired to, or detachable from, a public or private telephone network. Otherwise, the telephone may be a short range wireless phone such as a cordless telephone or a long range wireless phone such as a cellular telephone or satellite phone. Other examples of communication devices include a computer with a modem such as a portable computer, a personal digital assistant (PDA) or handheld computer such as a PALM PILOT with infrared linkage and the like, an email transmitting device such as a BLACKBERRY and the like, and any other Internet-linked device. Other devices include a radio transmission or receiving device (one-way or two-way devices), a citizens band (CB) radio, a short wave radio, a short-range communication device, a push-to-talk communication device (i.e. a walkie-talkie and similar devices), an image transmitting device including a camera that transmits images or video, a video relay services device, and closed-circuit television, a satellite network based-device, a Morse code transmitter and receiver, and any combination thereof. The communication device may also be a more stealth related communication device such as a watch that transmits and/or receives communications.

The vehicle 401 may also be equipped with any of the communication devices mentioned above. This provides for direct communication between the authorized beneficiaries and the vehicle and/or communication between the vehicle and the base 407. Thus, in one example, the base 407 can transmit new route or pick-up location changes to the vehicle and the vehicle can relay these changes to the authorized beneficiaries while the vehicle is traveling.

By one approach, a number of applications may require automatic transmissions. Thus, a number of the communication devices may be configured to transmit and/or receive data, signals, or messages automatically as is known. Optionally, other devices for automatically transmitting and/or receiving signals or data such as known transponders or transceivers may be used as location transmitters for indicating the location of authorized beneficiaries, vehicles, or both. Thus, the base 407 and/or the vehicle 401 may know the whereabouts of the authorized beneficiaries, and the authorized beneficiaries and the base 407 may track the location of the vehicle or vehicles.

Referring again to FIG. 4, the vehicle 401 itself can vary greatly with respect to the actual and/or anticipated circumstances as may concern its eventual use as a means of transporting others away from a pick-up location amid civil upheaval as has been occasioned by a civilly-catastrophic event. This can include differences with respect to the transport modality (or modalities) that characterizes the vehicle 401. Examples include, but are not limited to, air-borne vehicles (including fixed wing aircraft, helicopters, lighter-than-air vehicles, and hovercraft, to note but a few), terrestrial vehicles (including cars, vans, buses, trucks, earth-boring subterranean vehicles, and trains, to note but a few), water-borne vehicles (including boats, barges, and ships, submarines, and amphibious craft, again to note but a few relevant examples), a beast-of-burden powered vehicle (including wagons, carts, and so forth), and at least partially human-powered vehicles (including bicycles, pedaled mopeds, and so forth). In many cases, the vehicle 401 will comprise a piloted vehicle that requires an in-vehicle pilot. If desired, however, the vehicle 401 may also comprise a pilotless vehicle or a remotely piloted vehicle (where the vehicle operates under the control of an automated control system, a remotely-located pilot, or some combination thereof).

In many cases the vehicle 401 will comprise a terrestrial vehicle. In such a case it may be useful to configure and arrange the vehicle 401 to be able to traverse off-road conditions. Such a capability may be useful, for example, to successfully move past debris, stalled, blocked, or abandoned vehicles, impassable roadways, and so forth. This can comprise configuring the vehicle 401 with a higher-than-normal suspension, a heavy-duty suspension, all-wheel drive, and so forth. This may also comprise configuring the vehicle's engine to operate even when partially or fully submerged (as may occur when fording a flooded area). Such accoutrements are known in the art and require no further elaboration here.

In many cases the vehicle 401 will comprise a terrestrial vehicle that has a free-ranging capability to thereby freely navigate paved and unpaved surfaces of various kinds. In some cases, however, it may be useful to further configure and arrange the vehicle 401 to also selectively travel compatibly on railroad tracks. This may comprise, for example, outfitting the vehicle 401 with retractable flanged wheels that can be selectively lowered to interact compatibly with a set of railroad tracks. Such apparatus is known in the art. So configured, the vehicle 401 can selectively readily travel on railroad tracks which may, in a given time of need, comprise a relatively unblocked means of departing from a location of civil upheaval.

In many cases, the vehicle 401 will be configured and arranged to transport human passengers. As will be shown below in more detail, these human passengers may comprise, for example, the authorized beneficiaries of certain subscriptions 403 as pertain to accessing and using the vehicle 401. If desired, however, the vehicle 401 may further be configured to additionally transport non-human cargo. This cargo may comprise freight, personal property of at least one of the subscribers or authorized beneficiaries, animal and/or pet cages or carrying devices, and/or supplies for subscribers, beneficiaries, private or public shelters, and/or distribution centers. Thus, the transport service may also be used to aid in delivery services for private or public parties. By this approach, for example, such a vehicle can be delivering civil security provisions to authorized beneficiaries who wish to remain where they are while also picking up authorized beneficiaries who wish to vacate the area.

By one approach, the transport service provides, or is provided in addition to, additional resources. More specifically, some additional resources may be considered as a provision provided as part of the transport service. Alternatively, separate consideration-based private civil security subscriptions from subscribers may be accepted for providing civilly-catastrophic event-based access to certain of the additional resources provided in addition to the transport service. For instance, additional resources that may be considered as part of the transport service agreement may be survival supply items and/or equipment supplied on the vehicle. Supplies and equipment provided at another location unrelated to the transport service may be provided by its own separate agreement. Another resource may be access to a shelter which may be considered part of the transport service agreement if the transport service is expected to bring particular authorized beneficiaries to that shelter. Otherwise, access to the shelter may be a separately agreed upon additional resource. Likewise, survival training relating to the transport (such as reaching the pick-up location by foot, boarding the transport in dangerous conditions, and so forth) may be part of the agreed upon transport service while other aspects of the survival training unrelated to the transport service (such as how to live in a tent as one of many examples) may be agreed upon separately from the transport service.

Finally, by one approach, rescue service may be considered as part of the transport service agreement so that rescue service may be provided by a vehicle used for the transport service but also equipped for rescue service. In this case, a vehicle reserved for the transport service and traveling along its route(s) to the predetermined pick-up locations 303-305 may be diverted to find the current location of an authorized beneficiary and to rescue that authorized beneficiary. Of course, the vehicle may be initially sent out to the current location. Rescue service is described in detail in commonly owned U.S. patent application Ser. No. 11/381,277 which is fully incorporated herein as noted above.

Likewise, by another approach, the transport service may receive calls or information from an authorized beneficiary that wants or needs to be picked-up from a chosen “called-in” location that is other than one of the regular pick-up locations. In this case, the transport service may direct a vehicle traveling along its route, or send a vehicle out, to pick up the authorized beneficiary at the called-in location.

Other additional resources such as survival supply items and equipment may be provided on-board the vehicle, at the pick-up locations, delivered by the vehicle and/or pre-positioned anywhere along the route for those in the vehicle to use or place in the vehicle. The survival supply items may be, for instance, emergency survival items, life sustaining necessities, and/or non-necessities of human life. The life's necessities may include, but is not limited to, items relating to personal hydration supplies (for example, water or other beverages), nourishment, clothing, shelter (for example, collapsible tents, and so forth), environmentally borne threat abatement (gas masks and filtration devices), medical supplies, rescue supplies, and so forth. Such survival supply items may relate to consumable items (including consumable necessities of human life), non-consumable items (including non-consumable necessities of human life), or both. Illustrative examples of consumable items would include, but are not limited to: food supplies, potable water, personal hygiene supplies, and medical supplies, to note but a few. Illustrative examples of non-consumable items could include, but are not limited to: essential clothing items, personal protection items (such as face masks, gloves, hazardous materials handling garb, foul-weather gear, and so forth), bedding items, food preparation items, repair and maintenance tools, navigation equipment, communication items, and shelter items (such as, for example, a tent) to again note but a few.

The survival supply items may also include at least one non-necessity of human life. Illustrative examples in this regard might include, but are not limited to: a luxury consumable item, a luxury non-consumable item, non-human nourishment (for example, pet food), non-essential clothing, barter medium (including, for example, precious metals in a convenient barterable form), and/or an entertainment apparatus or content, to note but a few.

If desired, the survival supplies may also include a variety of equipment, or other survival items. For example, the survival supplies may include an additional transport for the authorized beneficiary to drive and that is met by the at least one vehicle for the transport service. This may include providing extra fuel storage tanks reserved for the additional transport.

By one approach, although any of the resources mentioned herein may be helpful if they are pre-positioned along a route a transport vehicle is to take, some resources may be particularly helpful. These may be resources that provide security or medical treatment, or may be supplies such as food and food preparation supplies, potable water, finite air supplies, batteries, hygiene supplies, sanitation supplies, personal protection items, bed linens, beds, evacuation tools, rescue tools and supplies, shelter items, a fuel supply, and a power source. The power source may be any known source including, but not limited to, a wind-based power generator, a photonically-based power generator, a fluid-based power generator, a thermo-electric power generator, and a stored-energy power generator. Any of the pre-positioned resources may be concealed and their location communicated to the personnel operating the vehicle traveling on the route with the pre-positioned resources. It will be understood that the pre-positioned resources may be intended for a particular vehicle, authorized beneficiary or route, or may be a general package intended for any beneficiary, vehicle, or route.

By another approach, the at least one vehicle 401 for the transport service is provided with enough supplies to act as a temporary shelter in case the vehicle breaks down, is immobilized, or it is beneficial for the authorized beneficiaries to wait in the vehicle for a relatively extended time period. This may occur, for example, when awaiting a different mode of transportation to arrive. Thus, the vehicle 401 may have survival supply items and fuel to run internal electrical or other systems for a specific or general amount of time such as a number of hours, days, or weeks, or any other time period deemed appropriate. The vehicle 401 may have many different types of supplies for these purposes as described above for the survival, entertainment and/or comfort of the authorized beneficiaries. For planned extended time periods, such equipment may even include educational materials, exercise or sports equipment, arts, craft, and/or mechanical trade training aids, and so forth.

As already alluded to above, and as will be made more clear below, the purpose of pre-positioning the vehicle 401 is to ensure its availability during a time of great need. Unfortunately, such a time will, essentially by definition, be characterized by significant temporary or permanent problems with the infrastructure of modern life. As a result, various significant mission-threatening problems can arise when seeking to use the vehicle 401 to transport a group of passengers away from a location of civil upheaval during such a time. As a result, it may be desirable to further equip 206 or outfit the vehicle 401 in various ways to better improve the prospects of the vehicle being able to successfully carry out its transport mission.

Thus, the vehicle 401 may be pre-supplied or outfitted with any of a variety of material that is designed to facilitate at least one of improving survivability of the passengers, improving the likelihood that the vehicle can complete its designated travel, and so forth. For instance, in at least some cases it may be anticipated that the civilly-catastrophic event of concern and/or the corresponding civil upheaval may involve, at least in part, unhealthy and/or dangerous ambient airborne contaminants. Examples include, but are not limited to, dangerous biological elements, dangerous chemical elements, dangerous radioactive elements, dangerous mutagenic influences, and so forth. These examples include both man-made and natural contaminants; for example, “chemical elements” can include both a man-made nerve gas and volcanic ash. By one approach, then, the vehicle 401 can comprise one or more passenger cabins that are substantially airtight. If desired, this can comprise configuring and arranging the passenger cabin to selectively have positive air pressure when desired to aid in urging external airborne contaminants from entering the passenger cabin. Various ways and means are known in the art by which to provide positive air pressure in a contained space and therefore require no further detailed description here.

Otherwise, the vehicle 401 may be equipped with breathing gas supplies, such as compressed air or oxygen generators and associated devices. Thus, a vehicle 401 may have a network of pipes and tubes to provide the air from air tanks to passengers as well as gas masks and other appropriate equipment.

As another example, at least some civilly-catastrophic events may be accompanied by an electromagnetic pulse. Such a pulse can permanently damage many electrical circuits including, for example, the electronic engine controls for a vehicle. With this in mind, it may be desirable to harden at least the critical vulnerable systems of the vehicle 401 to thereby substantially protect those systems against an electromagnetic pulse. Again, various equipment and devices for achieving such a result are known in the art and may be practiced here as desired.

Other examples of supplies and equipment provided on or in the vehicle include, but are certainly not limited to:

low-light vision equipment (including no-light) vision equipment (to facilitate night operations and travel in other vision-impaired settings). This may include thermal, infrared, light intensifier or other known devices as headware or mounted on the vehicle;

weapons and corresponding ammunition including personal and/or vehicle mounted weapons (or weapons incorporated into the fuselage of the vehicle), and whether lethal (such as, but not limited to, standard handheld and/or mounted firearms, knives, bows and arrows, crossbows and bolts, rockets, grenades, artillery, and so forth) or non-lethal (such as, but not limited to, rubber bullet-firing weapons, electrical charge-conveying weapons, nets, concussive incapacitation devices, drug-imparting darts, tear gas, long and short range acoustic devices, and so forth);

fire-fighting equipment (such as, but not limited to, fire extinguishing supplies and tools) for putting out fires at least on the vehicle;

first aid equipment (such as, but not limited to, first responder medical equipment and supplies, automatic external defibrillators, oxygen, lost blood replacements (such as blood, plasma, artificial blood, and so forth), wound dressings, stretchers and body boards, and so forth);

medical equipment (including but not limited to first aid supplies as well as first responder emergency medical services supplies such as blood, plasma, automatic external defibrillators, radiation exposure treatments, chemical exposure treatments, antibiotics (including but not limited to medicines such as Tamiflu and the like), and so forth);

navigation equipment (such as, but not limited to, electronic equipment, global positioning system-based equipment and aids, maps (in hardcopy and or virtual form), a compass, and so forth);

safety harnesses as needed for protection in a crash or while traversing difficult and bumpy terrain if a terrestrial vehicle, or for evasive maneuvers if an air-borne or sea borne vehicle;

flotation equipment (such as, but not limited to, personal floatation equipment for transport service personnel, authorized beneficiaries, and so forth);

at least one parachute (for emergency escape on an air-borne vehicle and to permit, for example, delivery of transport service personnel, their equipment, and/or other transport-related material);

deployable emergency lights (such as, but not limited to, electrically powered lights, constantly illuminated lights, flashing lights, chemically active lights (such as flares), and so forth);

whistles (such as noise makers of various kinds to aid, for example, with signaling, warning, and the like);

personal armor (such as, but not limited to, helmets, vests, gloves, boots, and so forth and containing projectile resistant or projectile proof materials such as Kevlar, metal, and so forth);

vehicle body armor (designed to stop at least low caliber small arms fire and offering higher ballistic protection if desired, including both bulletproof windows, louvered view ports, and armored passenger compartments and/or vehicle compartments);

radiation shielding;

biological/chemical agent protection (including but not limited to the aforementioned positive air pressure capability, decontamination facilities, sealed compartments, and so forth);

tinted one-way windows to hide the contents of the vehicle;

puncture proof, run-flat, and/or self-inflating tires;

spare vehicle parts (including but not limited to mission critical parts relating to the vehicle's wheels, drive train, propulsion system, trajectory controls, an electronic control module (ECM), and so forth);

supplemental vehicular fuel supplies (carried in on-board auxiliary fuel tanks and/or non-integral fuel containers of choice);

vehicular maintenance tools;

racks mounted on the vehicle to carry supplies on the exterior of the vehicle; and

equipment for holding passengers on the exterior of the vehicle when the environment is safe to do so (or when circumstances demand it);

to name but a few examples.

As mentioned above, the vehicle 401 may also be equipped to confirm the identification of an authorized beneficiary before permitting the authorized beneficiary to ride on the vehicle. Thus, the vehicle 401 may have biometric equipment, card readers, computers for entering pass codes, written or electronic lists of pass words, hard copy or electronic photos of authorized beneficiaries, cameras with a transmitter configured for transmitting an image of the authorized beneficiary to a base that can identify the authorized beneficiary, an admission card reader, identification documentation therefore, and/or voice print analysis devices.

In many cases it will be desirable to use at least two vehicles (401 and 402 on FIG. 4) although many more may be appropriate in some settings. When providing a plurality of vehicles, their transport modalities may be the same or may differ as desired. By one approach, this additional vehicle 402 (or vehicles) can represent redundant capacity and capability and hence as a backup for the first vehicle 401. By this approach, the second vehicle 402 can comprise, for example, passenger transport capacity that at least doubles the overall available transport capacity as is represented by the aforementioned subscriptions. Such redundancy with respect to capacity can aid with assuring, in turn, that transport for the passengers can be effected notwithstanding the difficult circumstances likely to characterize their transit.

By one approach, if desired, providing 102 arrangements for at least transport service includes arranging 210 for a secondary transport. In other words, a first vehicle 401 may be a primary transport and can comprise a passenger vehicle that is intended to transport a particular group of passengers while a second (and/or more) vehicle or secondary transport 402 comprises a security or escort vehicle that is intended to accompany the first vehicle 401 when the first vehicle 401 makes its assigned transit. So configured, this escort vehicle can be intended to perform such tasks as scouting candidate paths ahead of the first vehicle 401, following the first vehicle 401, or other security/protection related tasks as may be strategically or tactically advisable or useful in a given application setting. A number of the secondary transports 402 may be used to form a protective convoy. These secondary transports 402 may be heavily armored and/or armed and may be privately-owned military-style vehicles such as tanks, half-tracks, jeeps, High Mobility Multipurpose Wheeled Vehicles (HMMWVs or Hum-Vees), armed air-borne support therefore, and so forth.

By another approach, the secondary vehicle(s) 402 may be decoy vehicles that are visibly similar to the transport vehicle carrying the authorized beneficiaries and/or may be equipped to perform at least one decoy maneuver. This may include initiating an operation at the same point as the transport vehicle by driving in a different direction so that un-informed observers do not know which vehicle to follow. The secondary vehicle 402 may be equipped to drive off-road and into difficult terrain to confuse and/or trap parties following the secondary vehicle. Many other uses for the decoy vehicle are contemplated.

By yet another approach, the primary transport or vehicle 401 is configured to only travel along a certain portion of the route and one or more secondary vehicles 402 are sent from the primary vehicle 401 to the pick-up location(s) 303-305 to collect the authorized beneficiaries. In one example, the secondary vehicles 402 then bring the authorized beneficiaries back to the primary transport or vehicle 401. This may be necessary where the primary vehicle 401 is used to travel in one mode of transportation (such as on paved roads, or in the air to airports, or by boat to docks), and then the secondary transports) 402 are used to get to the pick-up locations 303-305 by a different mode or type of transportation (such as by off-road vehicles as one example).

In these cases, the secondary transport 402 may be configured for being mounted on and removably carried by the primary transport 401, configured for being pulled by the primary transport on a trailer, cart or the like, pushed by the primary transport, and/or configured for driving separately from the primary transport while accompanying the primary transport. Thus, the secondary transport 402 may be, but is not limited to, a terrestrial vehicle, an armored vehicle, an armed vehicle, an air-borne vehicle, a water-borne vehicle, a hovercraft, or an amphibious vehicle. Since one purpose of the secondary vehicle is to bring one or more authorized beneficiaries from a difficult to reach pick-up location and back to the primary vehicle, the secondary vehicle 402 may be smaller transports designed for specific or difficult terrain. Such a secondary transport includes those that may only hold one additional person other than the driver of the secondary vehicle. Thus, a secondary transport may be a motorcycle, a moped, a dune buggy, an all-terrain vehicle, an inflatable floatation device, a horse pulled in a trailer by the primary vehicle or carried by the primary vehicle 401, a pedaled vehicle configured and arranged to carry at least two people, a snow mobile, and/or a jet ski to name a few examples.

Referring again to FIGS. 2 and 4, the process 102 also includes maintaining 208 the vehicle 401 in a predetermined state of readiness. This may include conducting vehicle maintenance at one of the predetermined locations 301-302 and that requires spare parts for the at least one vehicle 401 for the transport service or any other vehicle associated with the transport service. Such spare parts might comprise, for example, spare fuses, spare illumination sources (such as head lights), and spare mechanical, electrical, and other maintenance parts of various types. Tools may be provided for repairing the at least one vehicle or replacing any device mentioned herein. All of these spare parts and tools may be stored as supplies 406 at the predetermined location 301. There are, of course, many other examples of spare parts and tools that may be provided.

Such maintenance can also optionally comprise making adjustments to such maintenance supplies as well as survival supply items for the vehicle and/or supplies 406 for the predetermined location 301 to reflect dynamically changing circumstances as occur during the consideration-based private civil security subscription period. As one illustration, a new item may become available that is particularly useful in dealing with or otherwise surmounting some condition that may likely arise upon the occurrence of a particular kind of civilly-catastrophic event. In such a case, maintaining such supplies can readily accommodate updating the acquired and stored items to include a supply of this new item.

Accordingly, such maintenance can readily comprise one or more of removing a particular one of the stored items (as when a better substitute becomes available, when the item itself is shown to be less effective for its intended purpose than was originally thought, and so forth), adding additional ones of a particular item (as when it becomes subsequently understood that more of a particular item is desirable to achieve a particular goal or purpose), adding at least one new stored item that is not already stored, and so forth.

Maintaining 208 the vehicle in a predetermined state of readiness may also include providing a supplemental supply of fuel in relatively close proximity to the vehicle, which supplemental supply of fuel is dedicated to use with the vehicle(s) at the predetermined location 301. By one approach, a vehicular fuel storage tank can be provided and further comprise a fuel pump such that vehicular fuel stored in the vehicular fuel storage tank can be readily transferred to the transport or other vehicle.

Maintaining 208 the vehicle 401 in a predetermined state of readiness may also include test-driving the vehicle from time to time (for example, on a scheduled basis and/or an un-scheduled basis), and test-operating the vehicle from time to time.

Maintaining 208 the vehicle 401 in a predetermined state of readiness at the predetermined location 301 can comprise, in part, optionally maintaining and storing the vehicle 401 in a covered shelter 404 at the predetermined location 301 for at least a substantial period of time pending a civilly-catastrophic event. This covered shelter 404 can be configured to house a plurality of such vehicles if desired. By one approach the covered shelter 404 may essentially comprise only a roof. By another approach the covered sheltered may also comprise one or more walls as well to further aid in protecting the vehicle(s) from the elements, unauthorized access, prying eyes, and so forth.

Much is known in the art regarding construction and maintenance of covered shelters (including both above ground and below ground facilities). Such a construction will usually at least serve to protect the vehicles and their supplies from environmental stress and extremes. In addition to walls and a roof as previously mentioned such a covered shelter may also optionally comprise internal temperature control, lighting, storage facilities, sleeping facilities, food preparation facilities, personal hygiene facilities, and so forth. For present purposes such a covered shelter may also be equipped to provide for water treatment (such as filtering, bacteria removal, and so forth), waste treatment and/or recycling, electrical power generation, and/or air treatment (including but not limited to conditioning, filtering, and so forth). By one approach such a covered shelter can also be equipped with communication facilities or be near the communications base 407 including a variety of wireless broadcast capabilities, long-distance two-way communications capabilities, any of the communication devices mentioned above, and so forth.

Such a covered shelter 404 can also comprise appropriate medical services facilities to facilitate the treatment of injured evacuees. These can comprise space, equipment, and other operational needs as may be necessary or useful to preserve and/or facilitate the offering of such medical services. This can include, but is not limited to, diagnostic equipment and supplies, medical procedure facilities (including surgical theaters), recovery facilities, laboratories, pharmaceutical storage facilities, reference materials, and meeting and personal accommodation space and facilities for the medical services personnel themselves.

If desired, this process 102 can also optionally comprise maintaining 209 personnel including providing at least one full-time crew member for the vehicle 401. By one approach this can comprise providing living quarters 405 at the predetermined location such that the at least one full-time crew member is available to facilitate substantially immediate operation of the vehicle 401 in response to a civilly-catastrophic event. The duties of this crew member can and will vary with the specific kind of vehicle and also with the nature of the particular transport task to be assigned to a particular vehicle. Exemplary duties comprise, but are not limited to, piloting the vehicle, co-piloting the vehicle, navigating the vehicle, conducting two-way wireless communications on behalf of the vehicle during transit, managing, serving, and otherwise attending to the needs of passengers, providing security, and so forth.

Regardless of whether full-time crew members are pre-provisioned as described above, the aforementioned maintenance of the vehicle 401 can further comprise conducting test drills with such personnel and/or with the intended passengers (i.e., the authorized beneficiaries of the previously mentioned subscriptions). Such drills can comprise, for examples, drills to practice locating and arriving at the predetermined location 301, assembling at a given pick-up location, preparing to enter the vehicle 401, entering the vehicle 401, taking a transport position within the vehicle 401, effecting safety provisions within the vehicle 401, exiting the vehicle 401 (under both emergency and non-emergency conditions), and performing and/or experiencing other circumstances or events of possible relevance or interest. Such drills may also entail, if desired, simulated and/or replicated transport conditions that may pose a particular challenge if encountered during a non-drill transport mission.

By yet another approach, the transport service may provide transportation to anyone at the pre-selected pick-up locations whether or not the passenger is a subscriber or authorized beneficiary of the subscriber. In this case, the crewmembers on a vehicle may provide rides to non-subscribers as long as there is sufficient space or open seats available on the vehicle. Such passengers may also pre-pay for the transport service upon learning of the service during an imminent threat of a catastrophic event. In such a case, payment for the transport service may be made by known automatic fund transfer methods over communication devices for example, in person at the pick-up location, or on the vehicle before the vehicle departs the pick-up location. When paying at or on the vehicle, the vehicle may be provided with a variety of known payment devices such as a cash box, cash change machine, credit card reader, and so forth. The non-subscribing passenger may also pay for the transport service while the vehicle is traveling or after the vehicle brings a non-subscribing passenger to a stop or destination.

So configured and arranged, transport service, which may be helpful or even critical to easing the plight of authorized beneficiaries and others affected by a given civilly-catastrophic event, is more likely to be quickly and relatively conveniently at hand. This, in turn, can greatly increase the tangible degree of civil security perceived and experienced by such persons. These teachings will readily accommodate a variety of approaches in this regard and these solutions are readily scalable to accommodate everything from relatively modest efforts to large scale prepatory activities.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. A method, comprising:
accepting consideration-based private civil security subscriptions from subscribers with respect to providing civilly-catastrophic event-based access to at least transport service for authorized beneficiaries; and
providing arrangements for at least the transport service comprising determining at least one pick-up location for collecting at least one authorized beneficiary by at least one vehicle and in association with a civilly-catastrophic event.

2. The method of claim 1 wherein accepting consideration-based private civil security subscriptions from subscribers comprises accepting the consideration-based private civil security subscriptions at a for-profit business.

3. The method of claim 1 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access;
option-based rights of access;
credit-based rights of access.

4. The method of claim 1 wherein accepting consideration-based private civil security subscriptions from subscribers with respect to providing civilly-catastrophic event-based access to at least transport service comprises accepting consideration-based private civil security subscriptions from subscribers with respect to providing civilly-catastrophic event-based access to at least one additional resource.

5. The method of claim 4 wherein the at least one additional resource comprises at least one of:
a survival supply item;
hydration;
nourishment;
a consumable necessity of human life;
a non-consumable necessity of human life;
at least one non-necessity of human life;
a breathing gas supply and associated devices;
an environmentally borne threat abatement mechanism;
access to a shelter;
a rescue service;
survival training.

6. The method of claim 1 further comprising:
using the transport service to additionally find and rescue at least one authorized beneficiary from a current location that is other than one of the pick-up locations.

7. The method of claim 1 further comprising:
receiving a communication from an authorized beneficiary to pick-up the authorized beneficiary at a called-in location that is other than one of the pick-up locations; and
using the transport service to pick-up the authorized beneficiary at the called-in location.

8. The method of claim 1 wherein the civilly-catastrophic event comprises an event that substantially disrupts society's infrastructure and an authorized beneficiary's ability to exist safely at an authorized beneficiary's pre-civilly-catastrophic event location.

9. The method of claim 1 wherein providing arrangements for at least the transport service further comprises arranging the transport service to occur at least one of:
before a predicted time of occurrence of the civilly-catastrophic event;
during the civilly-catastrophic event; and
after the civilly-catastrophic event.

10. The method of claim 1 wherein determining at least one pick-up location further comprises at least one of:
identifying pick-up locations that are in a vicinity of at least one authorized beneficiary;
identifying pick-up locations that are accessible to at least one type of selected mode of transportation;
identifying pick-up locations that are substantially disposed along a route to a selected destination.

11. The method of claim 1 wherein determining at least one pick-up location further comprises identifying pick-up locations that are likely safe to collect authorized beneficiaries depending on at least one of:
a nature of the civilly-catastrophic event; and
a societal infrastructure status in light of the nature of the civilly-catastrophic event.

12. The method of claim 11 wherein the nature of the civilly-catastrophic event and the societal structure status are determined by at least one of:
predictions;
monitoring of the pick-up locations by using surveillance equipment;
monitoring of the pick-up locations by reconnaissance personnel;
monitoring weather information;
monitoring media reports.

13. The method of claim 1 wherein providing arrangements for at least the transport service further comprises selecting a destination for authorized beneficiaries collected from the pick-up locations, the destination comprising at least one of:
a rally point for gathering authorized beneficiaries for further transportation;
an emergency shelter configured to be inhabited at least during the civilly-catastrophic event;
a short-term shelter configured to be inhabited for a defined relatively short-term duration;
a long-term shelter configured to be inhabited for a relatively long-term period;
a location having survival supplies;
a location a predetermined distance away from the civilly-catastrophic event such that the authorized beneficiaries at the location are relatively safe from the civilly-catastrophic event;
a location for reuniting authorized beneficiaries of a related group of authorized beneficiaries.

14. The method of claim 1 wherein providing arrangements for at least the transport service further comprises predetermining the routes to be traveled to and from the at least one pick-up location before an imminent threat of the civilly-catastrophic event is established.

15. The method of claim 1 wherein providing arrangements for at least the transport service further comprises communicating information regarding a plurality of the pick-up locations to the authorized beneficiaries such that the authorized beneficiaries can pre-select at least one of the plurality of pick-up locations as being a primary pick-up location for themselves during a civilly-catastrophic event-based time of need.

16. The method of claim 15, wherein communicating information further comprises at least one of:
providing location information of the plurality of the pick-up locations;
providing a pick-up schedule of times that the at least one vehicle will be present at the plurality of the pick-up locations;
providing a change for a pick-up schedule of times that the at least one vehicle will be present at the plurality of the pick-up locations;
providing communication instructions for informing authorized beneficiaries of changes in a pick-up schedule of times that the at least one vehicle will be present at the plurality of the pick-up locations;
providing information regarding identification of the at least one vehicle;
providing information regarding identification of at least one crew member responsible for accompanying the at least one vehicle;
providing information regarding authorized beneficiary identification requirements for an authorized beneficiary to gain authorization to board the at least one vehicle;
providing information regarding storage space provided on the at least one vehicle;
providing information regarding carry-on baggage requirements as pertain to the at least one vehicle.

17. The method of claim 15 wherein communicating information further comprises communicating the information by at least one of:
(a) before the civilly-catastrophic event is predicted to likely occur;
(b) after the civilly-catastrophic event is predicted to likely occur but before the civilly-catastrophic event occurs;
(c) after the civilly-catastrophic event occurs;
(d) before the at least one vehicle is traveling to at least one pick-up location;
(e) while the at least one vehicle is traveling to at least one pick-up location;
(f) while the at least one vehicle is waiting at least one pick-up location;
(g) after the at least one vehicle leaves at least one pick-up location.

18. The method of claim 1 wherein providing arrangements for at least the transport service further comprises providing at least one authorized beneficiary a communication device prior to the at least one vehicle arriving at least one of a plurality of the pick-up locations.

19. The method of claim 18 wherein the communication device is at least one of:
(a) a one-way communication device;
(b) a two-way communication device;
(c) a telephone;
(d) a wireless telephone;
(e) a cellular telephone;
(f) a satellite telephone;
(g) a computer;
(h) a portable computer;
(i) a personal digital assistant;
(j) at least one of: an email receiving device and an email transmitting device;
(k) an Internet-linked device;
(l) a radio;
(m) a citizens band radio;
(n) a short wave radio;
(o) a short-range communication device;
(p) a push-to-talk communication device;
(q) a Morse code-based device;
(r) an image transmitting device;
(s) a camera having at least a transmission receiving device;
(t) a watch having at least a transmission receiving device.

20. The method of claim 1, wherein providing arrangements for at least transport service further comprises providing the at least one vehicle with communication equipment for communicating with at least one of: a communications base and authorized beneficiaries.

21. The method of claim 20, wherein providing arrangements for at least transport service further comprises providing arrangements for communicating pick-up locations to the at least one vehicle while the at least one vehicle is traveling.

22. The method of claim 1 wherein providing arrangements for at least the transport service further comprises providing the authorized beneficiaries with at least one location transmitter for indicating a position of at least one authorized beneficiary.

23. The method of claim 1 wherein providing arrangements for at least the transport service further comprises providing the at least one vehicle with at least one location transmitter to indicate a location of the at least one vehicle.

24. The method of claim 1, wherein the vehicle is at least one of:
a terrestrial vehicle;
an armored vehicle;
an armed vehicle;
an air-borne vehicle;
a water-borne vehicle;
a hovercraft;
an amphibious vehicle;
a beast-of-burden powered vehicle;
an at least partially human-powered vehicle.

25. The method of claim 24 wherein the at least one vehicle is a terrestrial vehicle configured and arranged to traverse off-road conditions.

26. The method of claim 24 wherein the at least one vehicle is configured and arranged to travel compatibly on both paved surfaces and railroad tracks.

27. The method of claim 1 wherein the at least one vehicle is a primary transport for carrying authorized beneficiaries, and wherein providing arrangements for at least the transport service further comprises providing at least one secondary transport for transporting at least one authorized beneficiary from the at least one pick-up location to the primary transport.

28. The method of claim 27 wherein the primary transport uses a different mode of transportation than a mode of transportation used by the secondary transport.

29. The method of claim 27, wherein the secondary transport is at least one of:
configured for being removably carried by the primary transport;
configured for being pulled by the primary transport;
configured for being pushed by the primary transport;
configured for driving separately from the primary transport while accompanying the primary transport.

30. The method of claim 27, wherein the at least one secondary transport is at least one of:
a terrestrial vehicle;
an armored vehicle;
an armed vehicle;
an air-borne vehicle;
a water-borne vehicle;
a hovercraft;
an amphibious vehicle;
a motorcycle;
a moped;
a dune buggy;
an all-terrain vehicle;
an inflatable floatation device;
a horse;
a pedaled vehicle configured and arranged to carry at least two people;
a snow mobile;
a jet ski.

31. The method of claim 1 wherein providing arrangements for at least the transport service further comprises providing at least one escort vehicle that accompanies the at least one vehicle for protecting the authorized beneficiaries.

32. The method of claim 31 wherein the escort vehicle is at least one of armored, armed, and a privately owned military-style vehicle.

33. The method of claim 31 wherein providing at least one escort vehicle comprises providing a plurality of escort vehicles for forming a protective convoy.

34. The method of claim 1, wherein providing arrangements for at least the transport service further comprises providing at least one decoy vehicle that is at least one of:
configured to be visibly similar to the at least one vehicle;
configured to perform at least one decoy maneuver.

35. The method of claim 1 wherein the at least one vehicle is configured and arranged for carrying cargo and passengers.

36. The method of claim 35, wherein the cargo comprises at least one of:
freight;
personal property of at least one of: subscribers and subscriber beneficiaries;
supplies for at least one of: subscribers, beneficiaries, private shelters, public shelters, distribution centers;
animal cages.

37. The method of claim 1 wherein providing arrangements for at least the transport service further comprises providing the at least one vehicle with at least one resource comprising at least one of:
survival supply items;
personal hydration supplies;
nourishment;
clothing;
a consumable necessity of human life;
a non-consumable necessity of human life;
at least one non-necessity of human life;
a breathing gas supply and associated device;
electromagnetic pulse protection device;
electromagnetic pulse protection equipment;
an environmentally borne threat abatement mechanism;
equipment for remote operation of the at least one vehicle;
low-light vision equipment;
non-lethal weapons and corresponding ammunition;
lethal weapons and corresponding ammunition;
fire-fighting equipment;
first aid equipment;
medical equipment;
navigation equipment;
safety harnesses;
floatation equipment;
at least one parachute;
emergency lights;
whistles;
personal armor;
vehicle body armor;
radiation shielding;
biological/chemical agent protection devices;
puncture proof tires;
run-flat tires;
self-reinflating tires;
payment equipment;
a spare vehicle part;
a supplementary fuel supply and associated devices;
a vehicular maintenance tools;
a rack mounted on the vehicle to carry supplies on the exterior of the vehicle;
equipment to hold passengers on the exterior of the vehicle.

38. The method of claim 37 wherein providing at least one resource comprises pre-positioning a resource along a route for the at least one vehicle.

39. The method of claim 38, wherein the pre-positioned resource comprises at least one of:
security;
medical treatment;
a power source,
a luxury item;
food supplies;
potable water;
finite air supplies;
batteries;
hygiene supplies;
sanitation supplies;
personal protection items;
bed linens;
beds;
food preparation items;
evacuation tools;
rescue tools and supplies;
shelter items.

40. The method of claim 39, wherein the power source includes at least one of: a wind-based power generator; a photonically-based power generator; a fluid-based power generator; a thermo-electric power generator; a stored-energy power generator.

41. The method of claim 38 wherein the pre-positioned resource is concealed.

42. The method of claim 1 wherein providing arrangements for at least the transport service further comprises providing the at least one vehicle with equipment for confirming the identification of an authorized beneficiary by at least one of:
a biometric;
an identification card;
a still image;
a camera with a transmitter configured for transmitting an image of the authorized beneficiary;
an admission card;
a pass code;
a voice print;
a password.

43. The method of claim 1 further comprising:
acquiring at least one of an exclusive right and a non-exclusive right to operate the vehicle.

44. The method of claim 43 wherein acquiring at least one of an exclusive right and a non-exclusive right to operate the vehicle comprises acquiring the exclusive right via at least one of:
ownership;
leasing;
rental;
a barter arrangement.

45. The method of claim 1, wherein providing arrangements for at least the transport service comprises providing arrangements for at least one of:
conducting vehicle maintenance;
providing a supplemental supply of at least one maintenance fluid in relatively close proximity to the vehicle, which supplemental supply of at least one maintenance fluid is dedicated to use with the vehicle;
providing a store of spare parts for the vehicle;
test-driving the vehicle;
test-operating equipment on the vehicle.

46. The method of claim 1 wherein providing arrangements for at least the transport service comprises providing the vehicle with a passenger cabin that is substantially airtight.

47. The method of claim 46 wherein providing arrangements for at least the transport service comprises providing the vehicle with at least selectively activated positive air pressure within the passenger cabin.

48. The method of claim 1 wherein providing arrangements for at least the transport service further comprises maintaining personnel for operating the vehicle in a predetermined state of readiness.

49. The method of claim 1 wherein providing arrangements for at least the transport service further comprises providing at least one shelter for storing the at least one vehicle at a predetermined state of readiness.

50. The method of claim 1 wherein providing arrangements for at least the transport service further comprises obtaining vehicles on a need basis as a function, at least in part, of characteristics of the civilly-catastrophic event.

51. The method of claim 1 further comprising:
accepting payment on the at least one vehicle for transportation of non-subscribers.

52. The method of claim 1, wherein providing arrangements for at least the transport service further comprises equipping the at least one vehicle to be a temporary shelter in case the vehicle is immobilized.

53. A method, comprising:
pre-selecting, prior to a civilly-catastrophic event, at least one pick-up location for collecting a plurality of people to be evacuated from a designated area in association with the civilly-catastrophic event;
predetermining at least one route to at least one pick-up location for at least one vehicle before an imminent threat of the civilly-catastrophic event;
pre-positioning the vehicle at a predetermined location;
maintaining the vehicle in a predetermined state of readiness for being used substantially solely as a transport service to collect people at the at least one pick-up location in association with the civilly-catastrophic event.

54. The method of claim 53 wherein the vehicle is operated by a private entity for profit.

55. The method of claim 53 wherein the passengers pre-pay for riding the vehicle.

56. The method of claim 53 further comprising:
accepting consideration-based private civil security subscriptions from subscribers for providing access to the transport service for authorized beneficiaries of the subscriptions.

57. An apparatus, comprising:
a known location;
at least one vehicle provided at the known location;
a plurality of consideration-based private civil security subscriptions from subscribers with respect to providing civilly-catastrophic event-based access to at least transport service for collecting authorized beneficiaries of the subscribers at least one pick-up location.

58. The apparatus of claim 57, wherein the at least one vehicle is at least one of:
a terrestrial vehicle;
an armored vehicle;
an armed vehicle;
an air-borne;
a water-borne vehicle;
a hovercraft;
an amphibious vehicle;
a beast-of-burden powered vehicle;
an at least partially human-powered vehicle.

59. The apparatus of claim 57 wherein the at least one vehicle is a terrestrial vehicle configured and arranged to traverse off-road conditions.

60. The apparatus of claim 57 wherein the at least one vehicle is configured and arranged to travel compatibly on both paved surfaces and railroad tracks.

61. The apparatus of claim 57 wherein the at least one vehicle has at least one resource having:
survival supply items;
personal hydration supplies;
nourishment;
clothing;
a consumable necessity of human life;
a non-consumable necessity of human life;
at least one non-necessity of human life;
a breathing gas supply and associated device;
electromagnetic pulse protection device;
electromagnetic pulse protection equipment;
an environmentally borne threat abatement mechanism;
equipment for remote operation of the at least one vehicle;
low-light vision equipment;
non-lethal weapons and corresponding ammunition;
lethal weapons and corresponding ammunition;
fire-fighting equipment;
first aid equipment;
medical equipment;
navigation equipment;
safety harnesses;
floatation equipment;
at least one parachute;
emergency lights;
whistles;
personal armor;
vehicle body armor;
radiation shielding;
biological/chemical agent protection devices;
puncture proof tires;
run-flat tires;
self-reinflating tires;
payment equipment;
a spare vehicle part;
a supplementary fuel supply and associated devices;
a vehicular maintenance tools;
a rack mounted on the vehicle to carry supplies in the exterior of the vehicle;
equipment to hold passengers on the exterior of the vehicle.

62. The method of claim 57 wherein the at least one vehicle has a passenger cabin that is substantially airtight.

63. The method of claim 62 wherein the at least one vehicle has at least selectively activated positive air pressure within the passenger cabin.
